(19) United States
(12) Patent Application Publication
(10) Pub. No.: US 2010/0182403 A1
(43) Pub. Date: Jul. 22, 2010

(54) FILE FORMAT FOR ENCODED STEREOSCOPIC IMAGE/VIDEO DATA

(75) Inventors: Sung Moon Chun, Seongnam-si (KR); Gwang Hoon Park, Seongnam-si (KR); Doug Young Suh, Seongnam-si (KR); Kyu Heon Kim, Seoul (KR); Yong Hyub Oh, Seoul (KR); Tae Sup Jung, Seoul (KR)

Correspondence Address: ROTHWELL, FIGG, ERNST & MANBECK, P.C., 1425 K STREET, N.W., SUITE 800, WASHINGTON, DC, 20005, US

(73) Assignee: ENHANCED CHIP TECHNOLOGY INC., Seoul (KR)

(21) Appl. No.: 12/439,969

(22) PCT Filed: Aug. 29, 2007
(86) PCT No.: PCT/KR07/04151

§ 371 Date: Mar. 4, 2009

(30) Foreign Application Priority Data
Sep. 4, 2006 (KR) 10-2006-0084510
Oct. 16, 2006 (KR) 10-2006-0100258

(51) Int. Cl. H04N 13/00

(52) U.S. Cl. 348/43; 348/E13.001

(57) ABSTRACT

Provided is a file format for encoded image data which can be reproduced into a lifelike stereoscopic image by a display apparatus for displaying a stereoscopic image. The file format for an encoded stereoscopic image includes an image data unit containing image information of the encoded stereoscopic image and a header unit containing meta data used to decode and reproduce the image information of the encoded stereoscopic image contained in the image data unit. The header unit can include at least one header unit of a camera header sub-unit containing information on left and right cameras used to acquire the stereoscopic image, a codec header sub-unit containing information on the encoding of the stereoscopic image, and a display header sub-unit containing information on a barrier type display apparatus for receiving and reproducing the encoded stereoscopic image data.

### TECHNICAL FIELD

The present invention relates to an image codec, and more particularly, to a file format of encoded stereoscopic image or video data.

### BACKGROUND ART

A binocular stereoscopic image (hereinafter, referred to as a stereoscopic image) includes a pair of a left image and a right image acquired by photographing a subject with a left camera and a right camera which are spaced by a predetermined distance from each other. Since the left image and the right image are acquired by photographing the same subject but are different from each other in a viewpoint, image information thereof may be slightly different from each other depending on a surface characteristic of the subject, a position of a light source, and the like. The difference in image information between the left image and the right image acquired from the same subject is referred to as disparity.

The stereoscopic images mean images acquired by the use of the left camera and the right camera, respectively, but include three-dimensional images acquired by applying a predetermined transform algorithm to a monoscopic image in a broad sense. The stereoscopic images are generally used to give a three-dimensional effect to a subject to be displayed.

There are various methods of giving a three-dimensional effect to an image which is reproduced by a flat display apparatus such as a liquid crystal display (LCD) device and a plasma display panel (PDP) device by the use of a stereoscopic image. One is a method using a barrier type display apparatus. The barrier type display apparatus attracts attention as a next-generation display apparatus, since it can display both a monoscopic image and a stereoscopic image.

A merged combined image means an image formed by alternately arranging pixels of the pair of left and right images in the unit of a line. For example, as shown in FIG. 1, a merged combined image 12 may be formed by extracting and alternately arranging the odd vertical line pixels of the left image 10a and the even vertical line pixels of the right image 10b. The merged combined image may be formed by extracting the even vertical line pixels from the left image 10a and extracting the odd vertical line pixels from the right image 10b, or by extracting horizontal line pixels from the left image 10a and the right image 10b instead of the vertical line pixels.

FIG. 2 is a diagram illustrating a barrier type display apparatus. As shown in FIG. 2, in the barrier type display apparatus, a barrier polarizing plate formed of a polarizing film or a polarizing glass is attached or provided to a front surface of a display apparatus 20. A line-type barrier pattern 22 is formed in the barrier polarizing plate. Such barrier patterns can be basically classified into a vertical line type and a horizontal line type. The barrier patterns can be classified into a straight line shape, a saw-teeth shape, a diagonal line shape, and the like, depending on minute shapes of the vertical lines or the horizontal lines. The minute line shapes of the barrier patterns cause differences in the three-dimensional effect between images to be displayed.

When a merged combined image is displayed by such a barrier type display apparatus 20, the barrier polarizing plate 22 allows a left eye 24a to watch only the pixel liens of the left image and allows a right eye 24b to watch the pixel lines of the right image. Accordingly, by the use of the barrier type display apparatus, viewers can view an image having a three-dimensional effect with naked eyes instead of using any assistant instrument. In recent years, the barrier type display apparatuses were attractively used to display a three-dimensional image with a 3D television or a mobile electronic device such as a mobile phone, a PMP, and a DMB receiver.

A method of efficiently encoding a stereoscopic image is required to display a three e-dimensional image by the use of a flat display apparatus such as the barrier type display apparatus. An example of such a method is an encoding method using a multi-view profile (MVP) of MPEG-2. In this method, one of the left and right images, for example, the left image, is encoded as a base layer by the same method as encoding a monoscopic image and only correlation information of the other image, for example, the right image, with the left image is encoded, where the right image is used as an enhancement layer. Then, the flat display apparatus decodes the left and right images from the received bitstreams and creates and displays a merged combined image by the use of the decoded left and right image data or alternately displays the left image and the right image.

As another method of encoding a stereoscopic image, a method of encoding a merged combined image in the unit of a frame instead of the left image and the right image is known. This method is different from the above-mentioned method, in that an encoder extracts and creates the merged combined image and encodes the created merged combined image in the unit of a frame by the use of any known encoding method. Examples of the known encoding method can include a method of encoding a still image in accordance with JPEG and a method of encoding a moving image in accordance with MPEG-1, MPEG-2, MPEG-4, H.264/AVC, and VC-1.

The image data encoded by the known method of encoding a still image or the moving image is transmitted to and reproduced by a display apparatus supporting the encoding method, or is stored in a storage medium and then is reproduced by a display apparatus. In this case, a necessary correction work or an edition work may be performed on the image acquired by the left and right cameras before the image data is transmitted to the display apparatus. For example, security related data, copy right related data, and the like may be inserted into the image data. Alternatively, specific contents may be produced by the use of the stereoscopic image or a necessary correction operation may be performed on the acquired stereoscopic image in consideration of the characteristic of the display apparatus.

In general, data indicating a variety of additional information necessary to decode and display the encoded image data as well as data indicating the image information such as brightness and chrominance is also required for the display apparatus to decode and reproduce the encoded image data. Accordingly, data transmitted to the display apparatus includes a variety of additional data as well as the image data.

FIG. 3 is a diagram illustrating a file format of the conventional encoded image data to be transmitted to the display apparatus. Referring to FIG. 3, the file format 30 of the conventional encoded image data roughly includes a basic header sub-unit 32 and an image data unit 34. Here, the image data unit 34 can contain texture information such as brightness and chrominance, shape information which is information on backgrounds or objects, motion information, and a variety of image information defined in the encoding standards. The basic header sub-unit 32 can contain Meta data other than a variety of image information contained in the image data unit 34, which is information required for the display apparatus to decode and reproduce the image information contained in the image data unit 34.

It is restrictive to use the known file format 32 of the encoded image data shown in FIG. 3 without any change to reproduce stereoscopic image data. This is because the known data structure is generally used to display a monoscopic image and the information contained in the basic header sub-unit 32 and transmitted to the display apparatus cannot include all the information required to decode and reproduce a three-dimensional image which is a stereoscopic image. Accordingly, there is a need for a new file format which can contain all the information required to decode and reproduce the stereoscopic image data.

### DISCLOSURE OF INVENTION

### Technical Problem

Generally, two cameras are used to acquire a stereoscopic image, unlike the monoscopic image. The left image and the right image have an image information difference in brightness and chrominance, depending on the orientation of a light source at the time of acquiring the stereoscopic image. A special display apparatus such as a barrier type display apparatus is used to reproduce a three-dimensional image. However, due to specific characteristics of the stereoscopic images and/or specific characteristics of the display apparatuses, it is not easy to transmit all the information required to reproduce a lifelike three-dimensional image to a decoder by the use of the conventional file format of encoded image data.

Therefore, a technical goal of the invention is to provide a file format of encoded stereoscopic image or video data, which can enable the efficient encoding of a stereoscopic image having the specific characteristics, enable the producing of contents suitable for reproduction of a three-dimensional image from the acquired stereoscopic image, and enable the transmitting of information required to reproduce a lifelike three-dimensional image to a display apparatus for a stereoscopic image.

### Technical Solution

In order to accomplish the above-mentioned technical goal, according to an aspect of the invention, there is provided a file format for an encoded stereoscopic image, the file format including: an image data unit containing image information of the encoded stereoscopic image; and a header unit containing meta data used to decode and reproduce the image information of the encoded stereoscopic image contained in the image data unit.

In the above-mentioned aspect, the header unit may include at least one header unit of a camera header sub-unit containing information on left and right cameras used to acquire the stereoscopic image, a codec header sub-unit containing information on the encoding of the stereoscopic image, and a display header sub-unit containing information on a barrier type display apparatus for decoding and reproducing the encoded stereoscopic image data.

In this case, the camera header sub-unit may contain one or more of disparity information of a left image and a right image constituting the stereoscopic image, information on a distance between the left and right cameras, information on a frame rate of a left image and a frame rate of a right image captured by the left camera and the right camera, respectively, and information on a kind of the left and right cameras used to acquire the stereoscopic image.

The codec header sub-unit may contain one or more of information indicating whether the image information contained in the image data unit corresponds to a stereoscopic image or a different type of image, information on a method of constructing the image information contained in the image data unit, and information on an encoding method used to acquire the image information contained in the image data unit.

The display header sub-unit may contain both or one of information indicating a type of the barrier pattern of the barrier pattern type display apparatus for which the image information contained in the image data unit is optimized and information indicating a pitch of the barrier pattern of the barrier pattern type display apparatus for which the image information contained in the image data unit is optimized.

### Advantageous Effects

The conventional file format of encoded image data to be transmitted to a display apparatus is generally directed to a monoscopic image and does not consider characteristics of a stereoscopic image. Accordingly, the conventional file format could not contain all the information required for the display apparatus to reproduce a lifelike stereoscopic image. According to the invention, since a new file format of encoded stereoscopic image data suitable for a display apparatus which can reproduce a stereoscopic image or reproduce a monoscopic image and a stereoscopic image together is suggested, a display apparatus for reproducing a stereoscopic image can reproduce a lifelike three-dimensional image.

Particularly, according to the invention, information on barrier patterns of a barrier type display apparatus can be contained in the file format and the display apparatus can reproduce a three-dimensional image optimized for the barrier pattern by using the information on the barrier patterns.

### BRIEF DESCRIPTION OF THE DRAWINGS

FIG. 1 is a diagram illustrating a method of creating a merged combined image from odd vertical lines of a left image and even vertical lines of a right image.

FIG. 2 is a diagram illustrating a principle of displaying a stereoscopic image by the use of a barrier type display device.

FIG. 3 is a block diagram illustrating a conventional file format of encoded image data.

FIG. 4 is a block diagram illustrating a file format of encoded stereoscopic image data according to an embodiment of the invention.

FIG. 5 is a block diagram illustrating a detailed configuration of a camera header sub-unit in the file format shown in FIG. 4.

FIG. 6 is a block diagram illustrating a detailed configuration of a codec header sub-unit in the file format shown in FIG. 4.

FIG. 7 is a block diagram illustrating a detailed configuration of a display header sub-unit in the file format shown in FIG. 4.

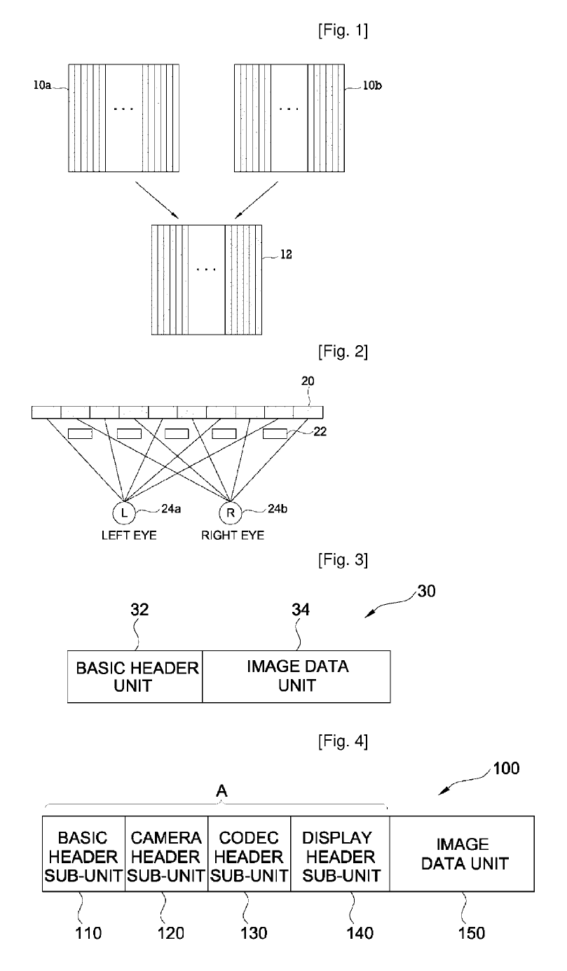

### BEST MODE FOR CARRYING OUT THE INVENTION

Hereinafter, exemplary embodiments of the invention will be described in detail with reference to the accompanying drawings. The embodiments to be described later are intended to only explain the technical spirit of the invention and thus the technical spirit of the invention should not be limited to the embodiments.

FIG. 4 is a block diagram illustrating a file format of encoded stereoscopic image data according to an embodiment of the invention.

Referring to FIG. 4, a file format 100 according to this embodiment includes at least one of a camera header sub-unit 120, a codec header sub-unit 130, and a display header sub-unit 140, in addition to a basic header sub-unit 110 and an image data unit 150. The file format 100 according to this embodiment uses the conventional file format (the basic header sub-unit 110 and the image data unit 150) of data of an image (monoscopic image or multi-view image encoded in accordance with a known encoding protocol such as a multi-view profile) encoded in accordance with JPEG, MPEG, H.264/AVC without any change, and further includes header units (the camera header sub-unit 120, the codec header sub-unit 130, and/or the display header sub-unit 140) containing additional information required to decode and/or reproduce a stereoscopic image.

In the conventional file format of data of an encoded image, a portion other than the image data unit 150 containing image information of pixels and the like can be considered as a header unit A. Accordingly, in the file format 100 according to this embodiment, the camera header sub-unit 120, the codec header sub-unit 130, and the display header sub-unit 140 constitute one header unit A along with the basic header sub-unit 110. However, the division of the header units 110, 120, 130, and 140 is arbitrary for the purpose of convenient explanation.

The names of the header units used in this embodiment are also arbitrary for the purpose of convenient explanation. According to this embodiment, it is important what data (which are described later in detail with reference to FIGS. 4, 5, 6, and 7) is contained in the header sub-units 120, 130, and 140 and concrete names thereof can be properly changed in accordance with the characteristics of information contained in the header sub-units or other related rules.

The header unit A in the file format 100 according to this embodiment further includes the camera header sub-unit 120, the codec header sub-unit 130, and the display header sub-unit 140, in addition to the basic header sub-unit 110. For example, in some examples, the header unit A may include the basic header sub-unit 120 and the codec header sub-unit 130, may include the basic header sub-unit 110, the camera header sub-unit 120, and the codec header sub-unit 130, or may include the basic header sub-unit 110, the camera header sub-unit 120, the codec header sub-unit 130, and the display header sub-unit 140. The header unit may include different combinations.

In FIG. 4, the camera header sub-unit 120, the codec header sub-unit 130, and/or the display header sub-unit and the basic header sub-unit 110 are distinguished from each other and arranged in a predetermined order, which is also for the purpose of only convenient explanation. Accordingly, in some examples, the arrangement order of the constituent elements contained in the header unit A can be changed. In some cases, the information of the header sub-units 110, 120, 130, and 140 can be contained in the same header sub-unit along with the information of the other header sub-units.

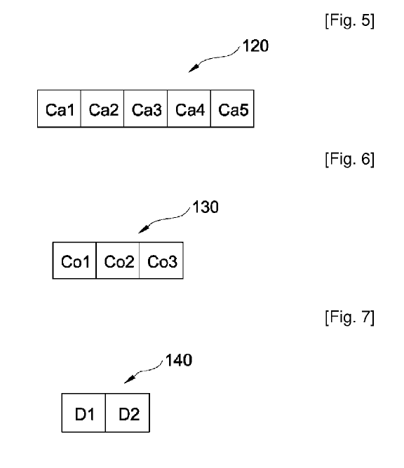

Information contained in the file format 100 of data of an encoded stereoscopic image according to this embodiment will be described now in detail with reference to FIGS. 4 to 7. Here, FIGS. 5, 6, and 7 are block diagrams showing detailed configurations of the camera header sub-unit 120, the codec header sub-unit 130, and the display header sub-unit 140 in the file format 100 shown in FIG. 4.

First, information similar or substantially equal to the information contained in the basic header sub-unit and the image data unit in the conventional file format (for example, see FIG. 3) of data of the encoded image is contained in the basic header sub-unit 110 and the image data unit 150. A variety of Meta data derived from encoding a monoscopic image or a variety of Meta data derived from encoding a multi-view image in accordance with the multi-view profile can be contained in the basic header sub-unit 110. However, as described later, information indicating whether the image information contained in the image data unit 150 corresponds to a general monoscopic image or a stereoscopic image may be further contained in the basic header sub-unit 110.

Information on brightness, chrominance, and shapes in the unit of pixel or block of the stereoscopic image and motion information are contained in the image data unit 150. The information contained in the image data unit 150 may be image information obtained by encoding a monoscopic image using a predetermined encoding method, image information obtained by encoding a merged combined image using a predetermined encoding method, or image information encoded using the known multi-view profile.

Information on the left and right cameras used to acquire the stereoscopic image is contained in the camera header sub-unit 120. For example, five types of information (block Ca1 to block Ca2, details of which will be described later) shown in FIG. 6a may be all contained in the camera head sub-unit 120, or a part of the five types of information may be contained in the camera header sub-unit 120 since the types of information are independent information on the left and right cameras.

Information indicating a difference in image information between the left image and the right image such as a difference in brightness (Y) and a difference in chrominance Cb and Cr or a difference in RGB value, that is, disparity information, is contained in block Ca1. In general, when a stereoscopic image is acquired from the same subject by the use of the left and right cameras spaced by a predetermined distance from each other, the difference in image information may occur between the left and right images, depending on the position of the lighting instrument (light source). For example, one of the left and right images may be brighter or darker than the other. Information on the difference in image information is contained in block Ca1.

It is preferable that the difference in image information of the stereoscopic image should be necessarily considered to improve encoding efficiency (compression efficiency) or reproduce a lifelike three-dimensional image. This is because the entire data amount may be increased when the difference in image information is not reflected therein and the three-dimensional effect of the stereoscopic image may be deteriorated.

In a method of encoding the difference in image information between the left and right images, the difference is encoded as image information contained in the image data unit 150. For example, when the left image and the right image are encoded in accordance with the multi-view profile, the disparity information is contained as correlation information between two images in the image data unit 150 and is encoded in the unit of a block, a picture, or a frame. However, this encoding method increases the data amount of the image data unit 150 to decrease a data compression rate. On the other hand, since a unit for encoding the disparity information is further provided in the known encoder, the configuration of the encoder may be complicated. It is very difficult to apply such an encoding method to encoding a merged combined image. A decoder has such stiffness that the stereoscopic image should be reproduced always in consideration of the disparity information regardless of the resolution or performance of the display apparatus.

Accordingly, in this embodiment, the disparity information is contained in block Ca1 of the camera header sub-unit 120 and is transmitted as the header information. Since the lighting instrument is not rapidly changed with the lapse of time in usual still images or moving images, it is possible to enhance the encoding efficiency as much by containing the disparity information in the camera header sub-unit 120 at a predetermined time interval. According to this embodiment, since the picture correction can be performed by the decoder in consideration of the resolution or performance of the display apparatus, the same decoder can be used in display apparatuses having various characteristics.

The disparity information can be expressed in various manners. For example, in case of disparity in brightness (or chrominance), a relative difference in average brightness value (for example, the average brightness value of the right image relative to the average brightness value of the left image) or an absolute difference (for example, the average brightness difference between the left image and the right image) between the left image and the right image can be expressed as the disparity information. The brightness difference between the left and right images can be measured at a predetermined time interval and can be periodically contained in block Cal of the camera header sub-unit.

Information on a distance between the left camera and the right camera is contained in block Ca2. The distance between the left and right cameras may be a distance between the center of the left camera and the center of the right camera, but is not limited thereto. The distance between the left and right cameras is usually fixed. However, depending on the characteristic of an image pickup device for acquiring a stereoscopic image, the distance may increase or decrease periodically or arbitrarily. In this case, the distance information may be periodically or freely contained in block Ca2.

The information on a distance between the left and right cameras contained in block Ca2 allows a center point of a stereoscopic image to be recognized in reproducing the stereoscopic image in a display apparatus having a decoder. The distance information provides a distance between the camera and the subject, thereby contributing to reproducing a lifelike three-dimensional effect of the stereoscopic image to be displayed. For example, the distance information may provide a viewer viewing the stereoscopic image with the optimum distance information for viewing the stereoscopic image or actual distance information between the subject and the camera.

Information on the number of frame per second (frame/sec, fps) of an image captured by the use of the left and right cameras, that is, information on the frame rate, is contained in block Ca3. The information on the frame rate may be information indicating the frame rates of the left and right cameras or indicating a difference from a specific reference (for example, 30 frames per second) (for example, 10 indicating the frame rate when 10 frames per second are captured by the left camera, or 20 which is a difference from the reference value). Alternatively, in some examples, the difference value in frame rate between the left and right cameras (for example, 20 which is a difference when it is assumed that the number of frames per second of the left camera is 30 and the number of frames per second of the right camera is 10) may be contained in block Ca3. The information on the frame rate may be contained in block Ca3 periodically, or may be added in block Ca3 as needed.

A widely used digital camera includes an image pickup device such as a CMOS image sensor or a charged coupled device (CCD). The digital camera is generally configured to capture images at 30 frames per second. However, when the lighting instrument is dark, the digital camera may capture the smaller number of images at 15 frames per second or 10 frames per second or less. Specifically, when the lighting instrument (light source) is deviated to one side, for example, when it is deviated to the left side, the left camera has high intensity of illumination and thus creates images at 30 frames per second. However, the right camera has low intensity of illumination and thus creates images at 15 frames per second.

In this case, the numbers of frames per second of the stereoscopic images captured by the left and right images are different from each other. When the stereoscopic images are reproduced by the display apparatus without considering this difference, it is difficult to reproduce natural and lifelike three-dimensional images. Accordingly, the encoder may perform an encoding process after correcting the number of frames per second, but the data amount to be transmitted increases in this case. Alternatively, the decoder needs to correct the difference in the number of frames per second to reconstruct the stereoscopic images and then reproduce the stereoscopic images by the use of the display apparatus. Accordingly, the information on the number of frames per second of the cameras need be transmitted to the display apparatus having the decoder.

The method of correcting the stereoscopic image in the display apparatus on the basis of the information on the number of frames per second contained in block Ca3 can be embodied in various manners and the invention does not limit the method. For example, when the number of frames per second of the left camera is 30 and the number of frames per second of the right camera is 15, the insufficient right image may be reproduced by repeating the previous frames of the right image or by interpolating the frames of the right image by the use of the previous images and the subsequent images.

Information on synchronization of the left image and the right image is contained in block Ca4. For example, as described above, when the numbers of frames per second of the left and right cameras are different from each other, the synchronization of the left and right images is necessary to reproduce an accurate stereoscopic image. When the data amounts of the left and right images are different from each other, the encoding times are different between the left and right images. When contents stored in a storage medium are used in the display apparatus later, the information on the synchronization between the left and right images is necessary. Accordingly, the information on the synchronization between the left image and the right image contained in block Ca4 contributes to reproducing an accurate stereoscopic image by correcting a temporal error between the left image and the right image in the display apparatus.

Information on the type of the left and right cameras used to capture a stereoscopic image is contained in block Ca5. The information on the type of the camera may be information on image quality of the camera indicating whether the camera is a full high definition (Full HD) camera, an HD-class camera, or an SD-class camera and/or information on the image pickup unit such as the CCD image sensor or the CMOS image sensor, but is not limited thereto. The information on the type of the left and right cameras contributes to enhancing the accuracy in image quality or the three-dimensional effect in reproducing a stereoscopic image in the display apparatus.

The codec header sub-unit 130 in the file format 100 for data of the encoded stereoscopic image according to an embodiment of the invention will be described with reference to FIGS. 4 and 6.

Information on the encoding of the stereoscopic image is contained in the code header sub-unit 130 of the file format 100. For example, three types of information (blocks Co1 to Co3, details of which will be described later) shown in FIG. 6 are all contained therein or a part of the three types of information may be contained therein since the types of information are independent information on the encoding of the stereoscopic image.

Information on a type of an image to be displayed is contained in block Co1. For example, the information contained in block Co1 may be information indicating that the image information contained in the image data unit 150 is intended to display a monoscopic image or a stereoscopic image or to display both the monoscopic image and the stereoscopic image.

The information of block Co1 is used to allow the display apparatus to identify the type of the image information contained in the image data unit 150. It is preferable that the display apparatus recognizes that the received image information or the image information to be reproduced is the monoscopic image or the stereoscopic image as soon as possible. In this case, the information of block Co1 may be disposed as front as possible in the data structure or the file format 100 according to this embodiment. For example, in some examples, the information contained in block Co1 may be contained in the basic header sub-unit 110.

Information on a method of constructing an image to be displayed is contained in block Co2. For example, when the information contained in block Co2 indicates that the image information contained in the image data unit 150 is a stereoscopic image, information indicating how to construct the stereoscopic image can be contained in block Co2. As described above, the stereoscopic image can be encoded in various methods such as encoding a merged combined image using a known encoding method and encoding both the left and right images using the multi-view profile. This information can be contained in block Co2. When a merged combined image is displayed by a bather type display apparatus, the merged combined image can be constructed in various methods (for example, a type where the vertical lines of the left and right images are alternately arranged or a type where the horizontal lines are alternately arranged) and this information can be also contained in block Co2.

It is assumed that a content received by the display apparatus is a stereoscopic image obtained by merging the entire left image and the even vertical lines of the right image. In this case, it is possible to view a monoscopic image when the display apparatus reproduces the left image and to view a stereoscopic image when the display apparatus reproduces the received entire content. That is, the barrier type display apparatus can display both the monoscopic image and the stereoscopic image. In this case, information on the method of constructing the monoscopic image and the stereoscopic image should be contained in the received information. Accordingly, the information on the method of constructing the monoscopic image and the stereoscopic image can be contained in block Co2.

Information on a method used to encode a stereoscopic image, for example, information indicating a type of a codec, is contained in block Co3. Here, the encoding of the stereoscopic image may mean to individually encode the left image and the right image or to encode a merged combined image. The stereoscopic image can be encoded using various codec methods such as JPEG, MPEG-1, MPEG-2, MPEG-4, H.264/AVC, and VC-1 and this information is contained in block Co3. Block Co3 can be used to indicate a codec method to be used to reconstruct a stereoscopic image in a decoder supporting various codec methods or to determine whether the received image data is data which can be decoded by the decoder supporting only a specific code method. Accordingly, the information of block Co3 may be disposed as front as possible in the data structure or the file format 100 according to this embodiment, similarly to the information of block Co1.

The display header sub-unit 140 in the file format 100 for data of the encoded stereoscopic image according to an embodiment of the invention will be described now with reference to FIGS. 4 and 7.

Information on the display apparatus for displaying a stereoscopic image is contained in the display header sub-unit 140 in the file format 100 according to this embodiment. For example, two types of information (block D1 and block D2, details of which will be described later) shown in FIG. 7 are all contained therein, or only one type of information of two types of information can be contained therein since the types of information are independent information on characteristics of the encoded stereoscopic image. The display header sub-unit 140 can contain information on a barrier pattern of a barrier type display apparatus.

Information on a type of a barrier pattern for which the stereoscopic image is optimized is contained in block D1. As described above, the types of the barrier pattern can be classified into a “1” shape, a saw-teeth shape, and a diagonal line shape and this information is contained in block D1. Information on a pitch of a barrier pattern for which the stereoscopic image is optimized is contained in block D2. The pitch of the barrier pattern may be constant all over the screen, or the pitch of the barrier pattern may be larger or smaller in the edge of the screen than the center portion of the screen. This information is contained in block D2.

Generally, in manufacturing contents using stereoscopic images acquired by the left and right images, a process of processing or correcting the image information in consideration of the barrier pattern of the display apparatus, that is, an adjustment process for manufacturing contents, is performed. This is intended to optimize the corresponding contents for a specific barrier pattern by considering that various types of barrier patterns exist and the pitches of the barrier patterns are various. When the barrier pattern of the contents is different from the barrier pattern of the display apparatus, it is, of course, possible to view a stereoscopic image. However, when the barrier patterns are not matched with each other, the three-dimensional effect or dynamic effect of the stereoscopic image cannot help deteriorating. Accordingly, the information contained in block D1 and/or block D2 indicates the barrier pattern for which the contents (that is, the image information contained in the image data unit 150) received by the display apparatus is optimized. When the barrier pattern of the display apparatus is different from the barrier pattern indicated by the information contained in block D1 and/or block D2, the image information contained in the image data unit 150 may be corrected and displayed so as to be suitable for the barrier pattern of the display apparatus.

While embodiments of the invention has been described in detail, it is obvious to those skilled in the art that the embodiments is intended to exemplify the invention and the technical spirit of the invention can be embodied in various forms.

### INDUSTRIAL APPLICABILITY

The invention can be advantageously used in the entire industrial fields of devices for encoding and/or decoding stereoscopic images, a display apparatus having such devices, and mobile devices such as mobile phones.

1. A file format for data of an encoded stereoscopic image, the file format comprising:
an image data unit containing image information of the encoded stereoscopic image; and
a header unit containing meta data used to decode and reproduce the image information of the encoded stereoscopic image contained in the image data unit.

2. The file format according to claim 1, wherein the header unit includes a camera header sub-unit containing information on left and right cameras used to acquire the stereoscopic image.

3. The file format according to claim 2, wherein the camera header sub-unit contains disparity information of a left image and a right image constituting the stereoscopic image.

4. The file format according to claim 2, wherein the camera header sub-unit contains information on a distance between the left and right cameras.

5. The file format according to claim 2, wherein the camera header sub-unit contains information on a frame rate of a left image and a right image captured by the left and right cameras, respectively.

6. The file format according to claim 2, wherein the camera header sub-unit contains information on synchronization of a left image and a right image constituting the stereoscopic image.

7. The file format according to claim 2, wherein the camera header sub-unit contains information on a kind of the left and right cameras used to acquire the stereoscopic image.

8. The file format according to claim 1, wherein the header unit includes a codec header sub-unit containing information on encoding the stereoscopic image.

9. The file format according to claim 8, wherein the codec header sub-unit contains information indicating whether the image information contained in the image data unit corresponds to a stereoscopic image or a different type of image.

10. The file format according to claim 8, wherein the codec header sub-unit contains information on a method of constructing the image information contained in the image data unit.

11. The file format according to claim 8, wherein the codec header sub-unit contains information on an encoding method used to acquire the image information contained in the image data unit.

12. The file format according to claim 1, wherein the header unit includes a display header sub-unit containing information on a barrier type display apparatus for receiving and reproducing the data of the encoded stereoscopic image.

13. The file format according to claim 12, wherein the display header sub-unit contains information indicating a type of the barrier pattern of the barrier type display apparatus for which the image information contained in the image data unit is optimized.

14. The file format according to claim 12, wherein the display header sub-unit contains information indicating a pitch of the barrier pattern of the barrier pattern type display apparatus for which the image information contained in the image data unit is optimized.
